(19) United States
(12) Patent Application Publication
(10) Pub. No.: US 2012/0057665 A1
(43) Pub. Date: Mar. 8, 2012

(54) Three Wavelength Coupling for Fusion Capsule Hohlraums

(75) Inventors: Edward I. Moses, Livermore, CA (US); Siegfried H. Glenzer, Oakland, CA (US); Pierre A. Michel, Oakland, CA (US); Laurent Divol, San Francisco, CA (US); Brian J. MacGowan, San Francisco, CA (US)

(73) Assignee: Lawrence Livermore National Security, LLC, Livermore, CA (US)

(21) Appl. No.: 13/108,895

(22) Filed: May 16, 2011

Related U.S. Application Data
(60) Provisional application No. 61/380,995, filed on Sep. 8, 2010.

(51) Int. Cl. H05H 1/02

(52) U.S. Cl. 376/103

(57) ABSTRACT

Using three tunable wavelengths on different cones of laser beams the energy transfer between beams can be tuned to redistribute the energy within the cones of beams most prone to backscatter instabilities. Using a third wavelength provides a greater level of control of the laser energy distribution and coupling in the hohlraum, to significantly reduce stimulated Raman scattering losses and increase the hohlraum radiation drive, yet maintain implosion symmetry.

### REFERENCE TO RELATED APPLICATIONS

This application claims priority from U.S. patent application Ser. No. 61/380,995, filed Sep. 8, 2010, and entitled “A 3 color scheme to optimize laser coupling in indirect-drive ignition hohlraums” which is incorporated by reference herein.

### STATEMENT AS TO RIGHTS TO INVENTIONS MADE UNDER FEDERALLY SPONSORED RESEARCH OR DEVELOPMENT

The United States Government has rights in this invention pursuant to Contract No. DE-AC52-07NA27344 between the United States Department of Energy and Lawrence Livermore National Security, LLC.

### BACKGROUND OF THE INVENTION

Fusion reactions combine hydrogen atoms together to form larger atoms, such as helium. Because the reactions take place at extremely high pressures and temperatures the electrons are stripped from the atoms resulting in positively charged nuclei, which repel each other. Overcoming this repulsion requires high energies, however, carrying out controlled nuclear fusion reactions promise enormous amounts of carbon free power.

Extensive research into implementation of a controlled fusion reaction is being carried out by the at Lawrence Livermore National Laboratory (LLNL). From a perspective of enabling the fusion reaction to occur in a controlled manner on earth, with the least amount of energy, deuterium (“D”) and tritium (“T”), isotopes of hydrogen, are a desirable source of fuel. In the approach being pursued at LLNL's National Ignition Facility in Livermore, California, the world's largest and highest-energy laser focuses the energy of laser beams on a BB-sized capsule filled with D-T fuel. NIF's goal is to fuse the D-T nuclei and produce more energy than the laser energy required to initiate the reaction.

At NIF a single laser beam is split into 192 beams which are subsequently individually amplified by a trillion times or more, with the goal of providing enough energy to overcome the repulsive forces of the hydrogen isotopes. The approach being followed at NIF is known as indirect drive. In indirect drive, the fusion capsule is surrounded by a hohlraum, and it is the hohlraum which is irradiated by the laser beams, instead of the capsule. The laser beams are focused onto the inside of the hohlraum, creating a superhot plasma, and generating X-rays. The X-rays from the plasma are absorbed by the capsule surface, causing the outer layer of the fusion capsule to explode. The material exploding off the surface causes the D-T inside the capsule to be driven inwards. The resulting density of the D-T fuel is not high enough to create fusion, however, shock waves also form and travel into the center of the fuel further raising the density in a center spot of the capsule. D-T fusion in the spot results in energetic alpha particles which travel only a short distance in the highly compressed fuel, further heating the fuel and causing more fusion reactions. The process spreads outward from the “hot” spot, creating a self-sustaining burn, referred to as ignition.

There are many challenges of carrying out a controlled fusion reaction. With regard to this invention, two important ones are: maximizing energy delivery to the capsule and controlling symmetry of the imploding fuel. The indirect drive approach to inertial confinement fusion (ICF) requires efficient and balanced energy deposition of multiple laser beams into the inside wall of the hohlraum. Laser plasma instabilities determine the laser energy deposition into the hohlraum wall. In particular, forward-scatter or side-scatter between laser beams crossing at the laser entrance holes of the hohlraum lead to transfer of energy between cones of beams and influence the hohlraum radiation symmetry. Backscatter instabilities also cause energy losses, and an imbalance of the energy deposited onto the wall.

Energy transfer between laser beams crossing in a plasma has been studied as to its potential impact on achieving ignition at NIF. Experiments have shown that two crossing laser beams can transfer energy to one another via stimulated Brillouin scattering. This is a three waves process between the two beams and the ion acoustic wave excited by their beat wave. The relevance of this process for ignition includes its impact on implosion symmetry, a crucially important aspect if a controlled fusion reaction is to be used as an energy source.

The first quantitative estimates of energy transfer between laser beams in a NIF hohlraum were provided using computer simulations and ray tracing between a few pairs of beams. It demonstrated that a wavelength separation between cones of beams should allow a control of the energy transfer. At NIF a two wavelength system was implemented, allowing changing the wavelength of the “outer beams” (which strike the hohlraum walls near the laser entrance holes to provide x-ray flux on the poles of the capsule), with respect to the wavelength of the “inner beams” (which hit the waist of the hohlraum to provide x-ray flux on the equator of the capsule). The inner beam wavelength is fixed at 351.07 nm (1053.2 nm before the third harmonic conversion), and the outer beams can be blue shifted by a few angstroms.

### SUMMARY OF THE INVENTION

We have developed a method of applying energy to a capsule to facilitate fusion by using groups of laser beams, at least three of the groups of laser beams having a different wavelength from each other. In our method, the capsule is positioned within a hohlraum having laser entrance holes at each end thereof and the laser beams enter the laser entrance holes, each of the at least three groups of beams being introduced at a different angle with respect to a central axis of the hohlraum.

In a preferred implementation, there are four groups of laser beams, each group entering the laser entrance holes at a different angle with respect to the central axis. A first set of two groups of laser beams form the largest angle between the central axis of the hohlraum and the laser entrance holes have the same wavelength. Preferably, these “outer beams” are at angles of about 44.5° and about 50° to the central axis. The inner beams are at angles of about 30° and about 23.5° to the central axis, and the wavelength of one group of the inner laser beams is different from that of the other group of inner beams by between about 0.5 and 1.7 Angstroms. The difference in wavelength transfers energy from the 23.5° group of laser beams to the 30° group of laser beams.

### BRIEF DESCRIPTION OF THE DRAWINGS

FIG. 1 illustrates the hohlraum and the imaging diagnostics used to correlate laser plasma instability to hohlraum energetics;

FIG. 1a illustrates the static x-ray imager images of the interior of the hohlraum wall through the laser entrance hole;

FIG. 1b illustrates the gated x-ray images of the capsule implosion symmetry;

FIG. 1c illustrates the SRS energy on the 30° quadruplet as remaining constant, despite the energy transfer from the outer beams to the inner beams;

FIG. 2a illustrates temperature fits from hot electron diagnostic equipment;

FIG. 2b illustrates the total SRS as a function of changes in wavelength;

FIG. 3 illustrates relationships between simulated hohlraum observables, with

FIG. 3a showing outer beam brightness, FIG. 3b showing pole-waist asymmetry and

FIG. 3c illustrating peak x-ray flux;

FIG. 4a illustrates the ratio of energy after to before crossed beam transfer for each cone of beans; and

FIG. 4b illustrates energy in the 23.5° cone after crossed beam transfer.

### DETAILED DESCRIPTION OF THE PREFERRED EMBODIMENTS

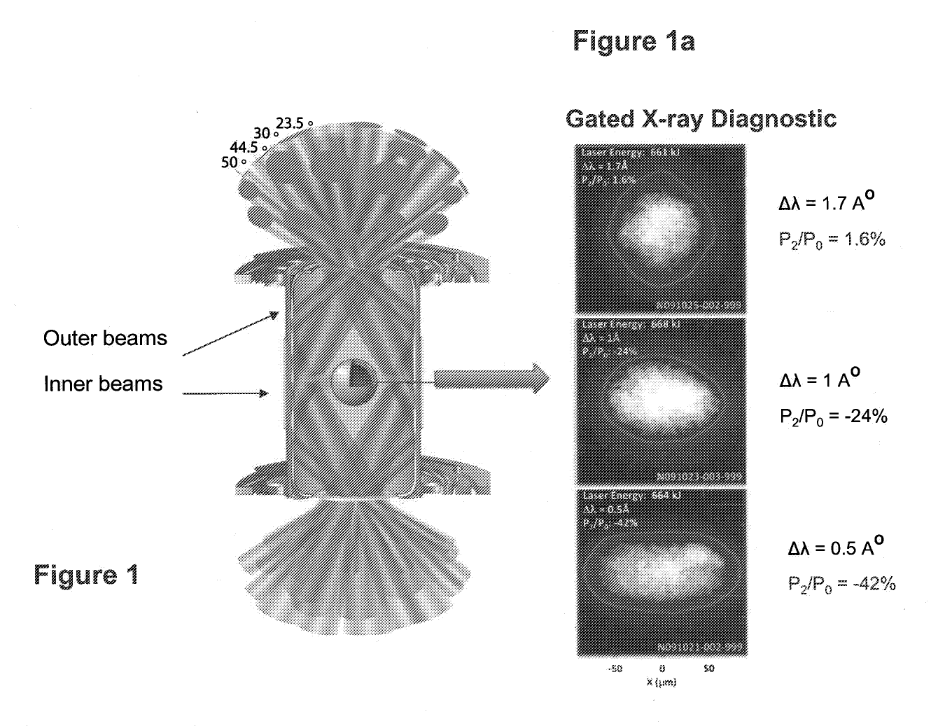

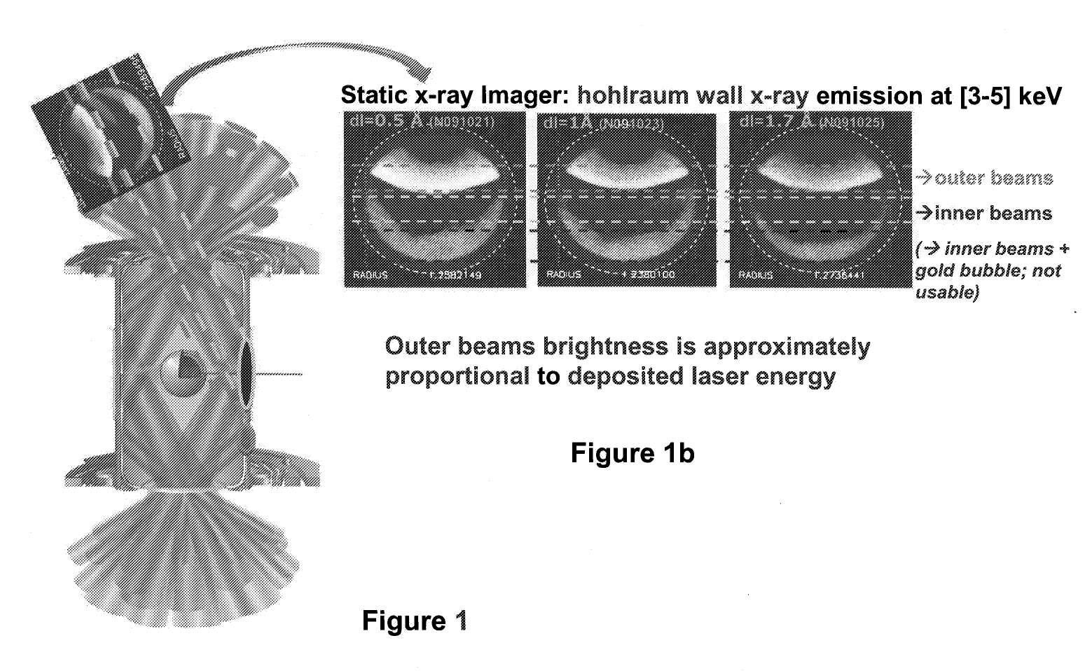

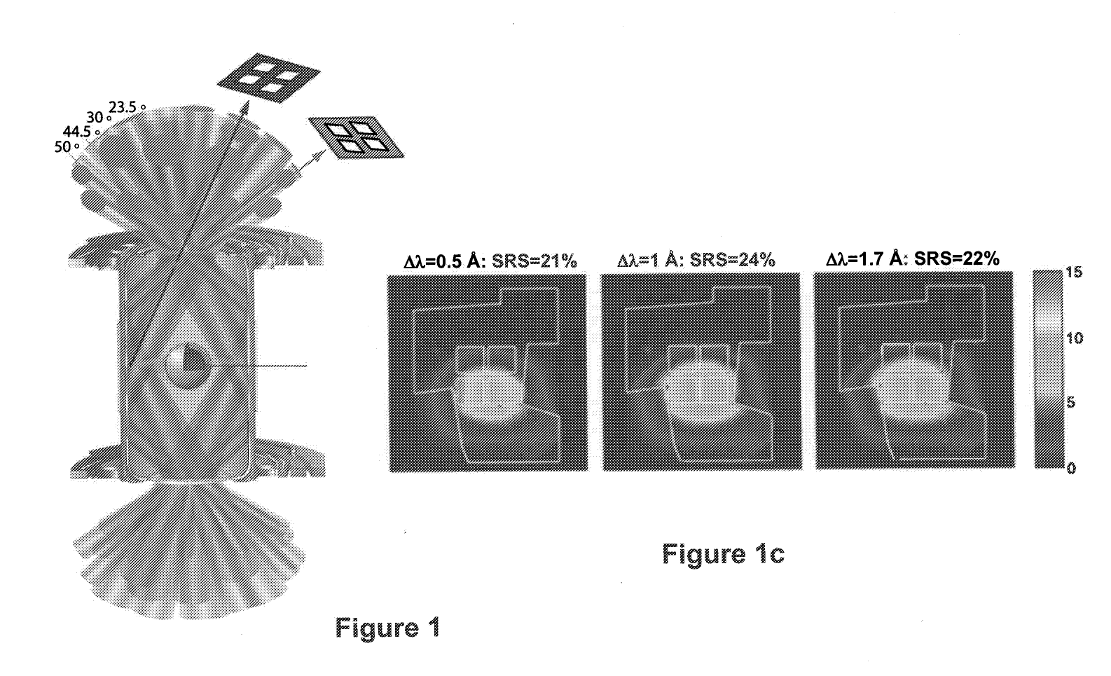

In recent experiments at NIF, crossed-beam energy transfer was used to adjust the energy balance on the hohlraum wall and achieve more symmetric capsule implosions. As shown in FIG. 1, on the NIF, the “inner beams” are at 23.5° and 30° from the hohlraum axis and irradiate the hohlraum near its “waist,” i.e. the mid-point of its length between the upper end and the lower end. These beams are generated by a first oscillator operating at wavelength λinner. The “outer beams,” also shown in FIG. 1, are at 44.5° and 50° from the hohlraum axis and hit the hohlraum wall further from the capsule, that is closer to the ends—laser entrance holes—of the hohlraum. These are provided by a separate oscillator at wavelength λouter. We have discovered that increasing the wavelength separation between the inner and outer beams (Δλ=λinner−λouter) leads to energy transfer from the outer to the inner beams. This increases the energy balance towards the hohlraum waist, leading to more prolate implosion symmetry. As Δλ was tuned from 0.5 Angstroms to 1.7 Angstroms, however, in these experiments, the hohlraum peak radiation flux dropped by 7%. This indicates a reduction in hohlraum coupling from 93% to 86%, while the total stimulated Raman scattering (SRS) losses increased by a factor of 3.4.

We have also discovered that by using three tunable wavelengths for the laser beams we can redistribute the laser energy within the inner cones of beams, which are most prone to backscatter instabilities. Our experiments show consistent trends relating the crossed-beam energy transfer to the increase in SRS losses and decrease in soft x-ray flux. In our three wavelength approach, we redirect the laser energy from the 23.5° beams into the 30° beams, which show no increase in backscattered SRS energy as more energy is transferred to them. Our research indicates that the total SRS losses are reduced by a factor of two to three, while maintaining high implosion symmetry.

In our experiments Δλwas tuned to achieve a round implosion symmetry, e.g. as shown in the middle illustration of FIG. 1a. The capsules were cryogenically cooled hohlraum emulators at 84% scale, with 4.6 mm diameter, with the laser delivering a total energy of 660 kJ in a 16 ns pulse. The hohlraum was filled with pure He gas and its inner wall was coated with a mixture of gold (Au) and beryllium (B). The wavelength shifts (Δλ) described here are defined as the wavelength as applied to the hohlraum, that is, after frequency tripling in the beam path between the hohlraum and the laser.

FIGS. 1a, 1b and 1c summarize the experimental information collected. FIG. 1a shows, using a gated x-ray diagnostic, images of the capsule x-ray emission at the time of peak emission, with the images being integrated over 75 ps. Note that as Δλwas tuned from 0.5 to 1.7 Angstroms, the energy transfer from the outer beams to the inner beams led to a less oblate capsule implosion. By introducing a wavelength shift (Δλ) between 0.5 and 1.7 Angstroms, the implosion symmetry is shifted to closer to spherical, that is, from P2/P0 equals −42% to P2/P0 equals 1.6%, where P2 represents the vertical axis and P0 the horizontal axis.

The variation of the laser beams brightness as they strike the hohlraum wall is measured by the static x-ray imager as shown in FIG. 1b. This diagnostic apparatus captures time-integrated images of the interior of the hohlraum wall x-ray emission at 3-5 keV through the laser entrance holes. Because the backscatter losses on the outer beams were negligible (<1%), the static x-ray imager provides a direct measurement of the decrease of the laser energy deposited on the hohlraum wall by the outer beams. It indicates that the outer beams energy on the wall decreased by about 30% from Δλ=0.5 to 1.7 Angstroms. The inner beams are not visible on the static x-ray imager—they have half the energy of the outer beams. Their relative energy increase from crossed-beam transfer is about +60%.

Another diagnostic apparatus known as “Dante” measures the x-ray spectrum from 0 to 20 keV as emitted through the laser entrance holes. That measurement showed a reduction of the peak x-ray flux of 7%±2.5% as Δλwas tuned from 0.5 to 1.7 Angstroms. This indicates increasing losses in the hohlraum as more energy was transferred from the outer to the inner beams.

Other diagnostic apparatus detecting backscatter detected negligible backscatter measured on the 50° beam quadruplet, while the 30° beam quadruplet measured a nearly constant SRS backscattered energy as Δλwas tuned from 0.5 to 1.7 Angstroms, despite the drop in x-ray flux measured by Dante. The time-integrated reflectivity (relative to the input energy of that 30° beam quadruplet) was between 21% and 24% for all three Δλ (i.e. ˜25 kJ of total SRS energy for the 30° cone). This is illustrated in FIG. 1c. No stimulated Brillouin scattering was measured on the 30° beams.

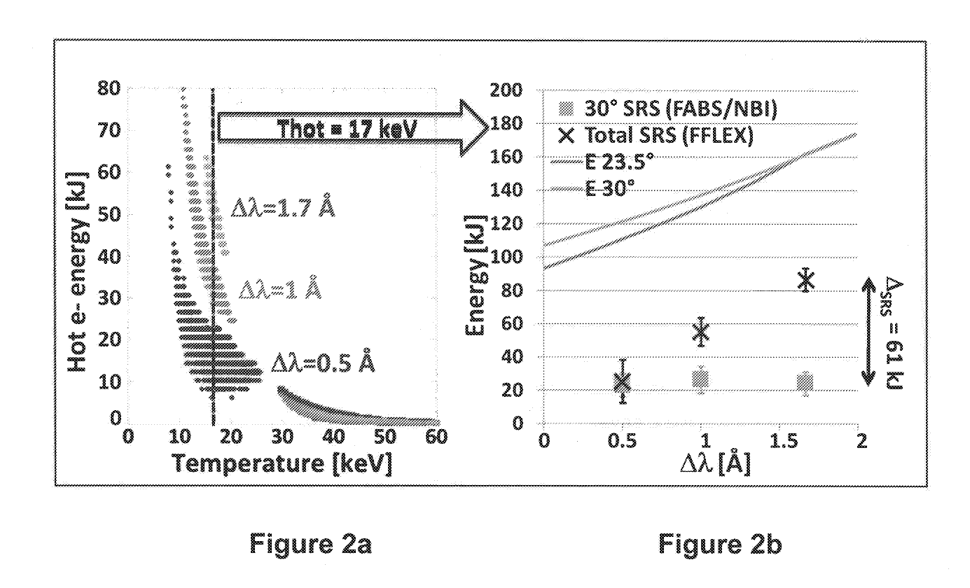

A quantitative analysis of another diagnostic known as FFLEX showed an increase in hot electron energy as Δλ increased. FIG. 2a shows temperature fits of this data for the three experiments. Each pair of points (one with Thot˜10-20 keV and another at 30-60 keV) corresponds to one particular fit; any plotted fit has each of its spectral channels voltage within 10% of the overall best fit. Using the SRS spectra measured (the average SRS wavelength was about 560 nm; the time-resolved spectra were very similar between the three shots), we inferred a temperature of 17 keV for the hot electrons generated by SRS. Using this temperature as a constraint on the fits, the total SRS energy loss can be estimated using Manley-Rowe relations. This shows a strong increase of the total SRS with Δλ, as shown in FIG. 2b. The total SRS energy loss increases from 25.5±13 kJ for Δλ=0.5 Angstroms to 87±7 kJ for Δλ=1.7 Angstroms, while the 30° SRS energy stays nearly constant around 25 kJ. (The extra increase in SRS losses is currently believed to be coming from the 23.5° beams, which were not measured.)

FIG. 2b therefore suggests that the extra SRS backscattered energy (=total−30°) increases from 2.4±14.5 kJ at Δλ=0.5 Angstroms to 62.5±10 kJ at Δλ=1.7 Angstroms. This corresponds to 9%±2.7% total energy loss, which is consistent with the 7.1%±2.5% drop in peak x-ray flux observed in Dante over the same wavelength range.

These experimental observations have led us to develop an integrated laser plasma instability and radiation-hydrodynamics model to assist in understanding our experimental results, as well as to design new experiments. We use the Lasnex radiation-hydrodynamics code with the DCA atomic physics model and a flux limiter f=0.15. This model brings the SRS and SBS spectra calculated using linear gains with the LIP code in good agreement with those measured. This observation validates the electron density and temperature modeling of the interior of the hohlraum. In NIF size hohlraums, a higher emissivity model leads to higher plasma emissivities, reducing the energy deposited in the coronal plasma and increasing soft x-ray fluxes measured by Dante in accordance with experimental measurements. A crossed-beam energy transfer model simultaneously calculates linear kinetic couplings between all of the 24 quadruplets of beams crossing at the laser entrance holes. The ion acoustic waves are calculated with a constant “ad-hoc” saturation level , matching the experimental data on several shots with various hohlraum sizes, laser pulse shapes and energies. The measured total backscatter is removed from the simulations input laser power after the energy transfer is applied.

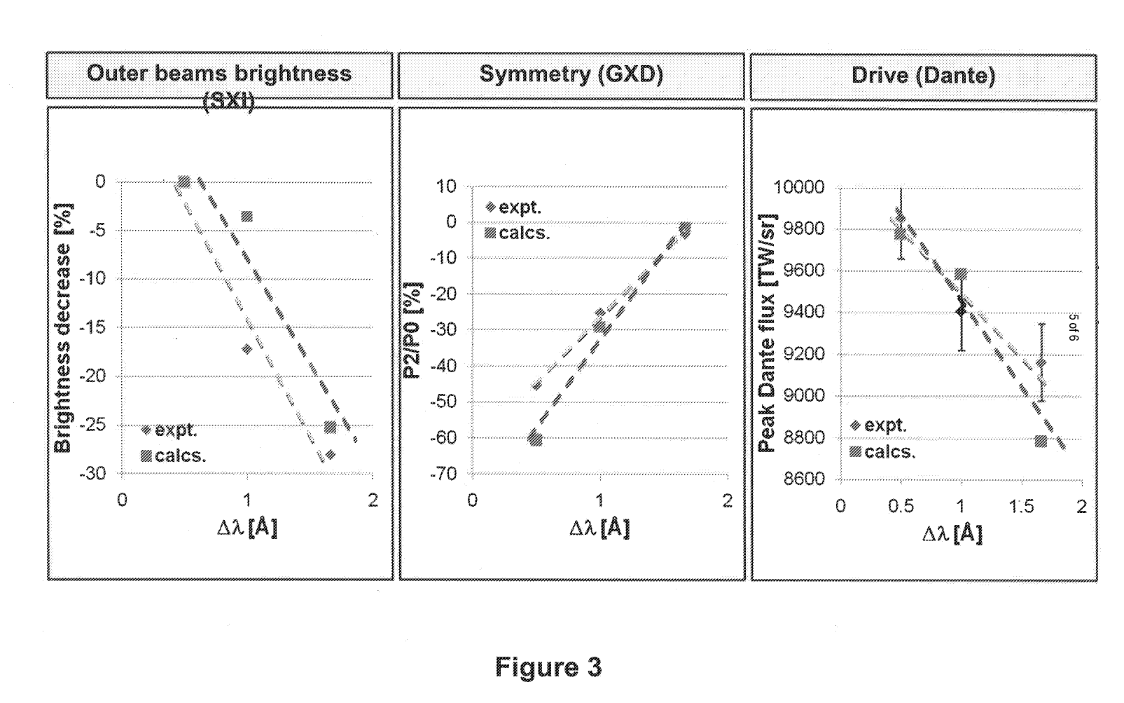

A comparison between the experiments performed and simulation results is shown in FIG. 3. The simulated results show reasonable agreement with the experiments. At 0.5 Angstroms, the model predicts negligible crossed-beam transfer (+1.5% toward the outer cones), and an oblate implosion was observed in the experiments. The asymmetry is due to the losses on the inner beams, i.e. the high SRS and the absorption in the cold plasma (Te<2 keV around the capsule). The cone fraction, defined as the ratio of the inner cone energy to the total energy (after energy transfer and laser plasma instability losses), needs to be about 40-45% to obtain a round implosion. As Δλ is increased to 1.7 Angstroms, the ˜60% energy increase of the inner beams from crossed-beam transfer leads to the required cone fraction for symmetric implosion; however, the increased laser energy deposition in the plasma and the increase in SRS reduce the total laser energy reaching the hohlraum wall, resulting in the drop in x-ray flux.

The different behavior between the total SRS and 30° SRS caused us to implement a third laser wavelength on NIF. This third oscillator will seed the 23.5° cone, separately from the 30° cone and the outer cones. This enables two tunable wavelength separations: Δλout=λ(44.5, 50)−λ(30) and Δλ23.5=λ(23.5)−λ(30).

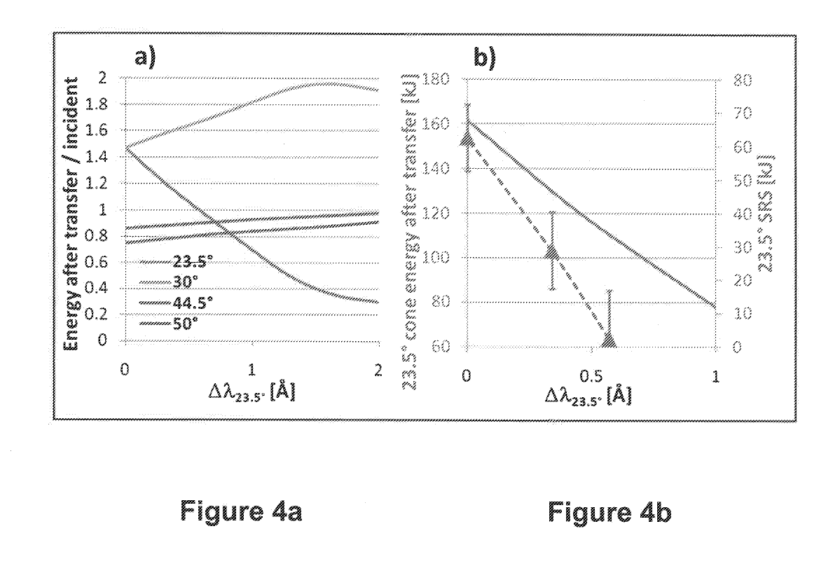

The effect of shifting Δλ23 while keeping Δλout fixed at 1.7 Angstroms is shown in FIG. 4a. If the 23.5° and 30° beams have the same wavelength, they can only exchange energy if there is a flow pattern that can Doppler-shift their beat wave. Since these beams are azimuthally clocked on NIF, that would require an azimuthal flow, which is negligible in hohlraum targets where the flow is essentially axisymmetric. On the other hand, if a wavelength separation is introduced between these beams, then the transfer becomes larger than between an inner and an outer beam with a similar shift due to a much larger overlap volume. Therefore, shifting Δλ introduces significant energy transfer from the 23.5° cone to the 30° cone while the outer cones remain nearly constant, as seen in FIG. 4a. This means that energy can be redistributed between the two inner cones with minor impact on the outer cones. In addition, the cone fraction can be accurately readjusted by a small change in Δλ if needed. In our three-dimensional simulations of 6 quadruplets of NIF beams, we found modification of the 30° beams intensity distribution is similar between a Δλ23 and a Δλout tuning.

Our strategy to improve coupling is thus to tune Δλ23 to transfer energy into the 30° beams which do not show increase in SRS backscattered energy vs. energy transfer. Assuming the additional SRS energy loss is coming from the 23.5° beams, their SRS threshold appears to be near 110 kJ, as shown by FIG. 2b. FIG. 4b shows that a shift of Δλ>0.6 Angstroms will bring the 23.5° cone below this threshold, bringing the total SRS losses back to 25 kJ. This recovers the 7% loss in drive when going from Δλ=0.5 to 1.7 Angstroms (FIG. 3c), while preserving the overall symmetry (P2/P0˜0).

To summarize, using our approach to control the laser beams coupling and energy deposition results in greater control of applied beam energy in NIF. The hydrodynamics and laser plasma interaction model we developed matches the experimental results on crossed-beam energy transfer, hohlraum drive and capsule implosion symmetry. Detailed analysis of experiments suggests that the total SRS losses are sensitive to the laser energy after transfer, while the 30° SRS losses are not. This third wavelength can transfer energy from the 23.5° into the 30° beams, while keeping the outer beams nearly constant due to the flow structure inside the hohlraums. Our hydrodynamics/laser plasma instability integrated model estimates that a wavelength shift of the order of one Angstrom between the 23.5° and 30° beams significantly reduces the total SRS, while increasing the radiation drive in the hohlraum and maintaining good implosion symmetry.

Here we have described numerous specific configurations, parameters, and the like to illustrate various techniques for implementing our three wavelength approach to improved hohlraum coupling. Other different specific configurations, parameters, dimensions, power levels, materials, concentrations, and similar details can also be used to implement the invention. Accordingly it is to be understood that the examples described above are for illustrative purposes only, and that various modifications or changes within the spirit of the invention and the scope of the appended claims.

What is claimed is:

1. A method of applying energy to a capsule to facilitate fusion comprising using groups of laser beams, at least three of the groups of laser beams having a different wavelength from each other.

2. A method as in claim 1 further including a fourth group of laser beams having the same wavelength as one of the at least three of the groups of laser beams.

3. A method as in claim 1 wherein the capsule is positioned within a hohlraum having laser entrance holes at each end thereof, each of the at least three groups of laser beams being introduced through the laser entrance holes at a different angle from each other with respect to a central axis of the hohlraum.

4. A method as in claim 2 wherein the groups of laser beams comprise four groups of laser beams, each group entering the laser entrance holes at a different angle with respect to the central axis.

5. A method as in claim 4 wherein a first set of two groups of laser beams forming the largest angle with respect to the central axis of the hohlraum and the laser entrance holes have the same wavelength.

6. A method as in claim 5 wherein a second set of two groups of laser beams forming the smallest angle with respect to the central axis of the hohlraum and the laser entrance holes have different wavelengths from each other and from the two groups of laser beams forming the largest angle with respect to the central axis of the hohlraum.

7. A method as in claim 4 wherein the groups of laser beams are at angles of about 44.5° , about 50° , about 30° , and about 23.5° to the central axis.

8. A method as in claim 7 wherein the wavelength of the groups of laser beams at angles of about 30° and about 23.5° are different from each other by between about 0.5 and about 1.7 Angstroms.

9. A method as in claim 6 wherein the difference in wavelength transfers energy from the group of laser beams at a smallest angle with respect to the central axis of the hohlraum to the group of laser beams at a next largest angle with respect to the central axis of the hohlraum.

10. A method of transferring energy from a first group of laser beams to a second group of laser beams, both the first group and the second group entering a hohlraum at an acute angle with respect to a central axis of the hohlraum, the method comprising shifting the wavelength of the first group of laser beams with respect to the second group of laser beams by between about 0.5 and 1.7 Angstroms.

11. A method as in claim 10 wherein the first group is at an angle of about 23.5° to the central axis, and the second group is at an angle of about 30° to the central axis, and energy is moved from the first group to the second group.

12. A method of controlling compression of a fusion capsule in a hohlraum having a central axis to make the compression more spherical comprising:
introducing a first group of laser beams of first wavelength at a first angle to the central axis;
introducing a second group of laser beams of second wavelength at a second angle to the central axis;
introducing a third group of laser beams of third wavelength at a third angle to the central axis;
wherein the first angle is smaller than the second angle and the second angle is smaller than the third angle; and the first wavelength is different from the second wavelength by between about 0.5 and 1.7 Angstroms.
